(19) United States
(12) Patent Application Publication
(10) Pub. No.: US 2013/0249783 A1
(43) Pub. Date: Sep. 26, 2013

(54) METHOD AND SYSTEM FOR ANNOTATING IMAGE REGIONS THROUGH GESTURES AND NATURAL SPEECH INTERACTION

(71) Applicant: Daniel Sonntag, Saarbruecken (DE)

(72) Inventor: Daniel Sonntag, Saarbruecken (DE)

(21) Appl. No.: 13/427,070

(22) Filed: Mar. 22, 2012

(51) Int. Cl. G06F 3/02; G10L 15/00

(52) U.S. Cl. 345/156; 704/E15.001

(57) ABSTRACT

The invention relates to a method and system for annotating image regions with specific concepts based on multimodal user input. The system (10) comprises an identification unit (11) for the identification of a region of interest on a multidimensional image; an automatic speech recognition unit (12) for recognizing speech input in a natural language; a natural language understanding unit (13) which interprets the speech input in the context of a specific application domain; a fusion unit (14) which combines the multimodal user input from the identification unit (11) and the natural language understanding unit (13); and an annotation unit (15) which annotates the result of the natural language understanding unit (13) on the image regions and optionally provides user feedback about the annotation process. Thus, the system advantageously facilitates a user's task to annotate specific image regions with standardized key concepts based on multimodal speech-based user input.

The invention relates to a method and system for annotating image regions with specific concepts based on multimodal user input. The concepts represent semantic descriptions of a multidimensional image and allow a classification or search of the images based on descriptive semantics.

### BACKGROUND OF THE INVENTION

Many companies and search engine providers cannot easily process their multimedia data. The problem is that many data, such as textual data and image data, are in a raw and unstructured form. It would be very advantageous to have data descriptors on image regions. The technical problem is that manual annotations are essential in the annotation step of the image regions, but the user interaction is often not user-friendly or inefficient.

For example, there is a growing need to store and organize all patient data, including health records, laboratory reports, and medical images. Effective retrieval of images builds on the semantic annotation of image contents. At the same time it is crucial that clinicians have access to a coherent view of these data within their particular diagnosis or treatment context. This means that with traditional user interfaces, users may browse or explore visualized patient data, but little or no help is given when it comes to the interpretation of what is being displayed. Semantic annotations should provide the necessary image information and a semantic dialogue shell should be used to ask questions about the image annotations while engaging the clinician in a natural speech dialogue simultaneously.

The problem is that a user in the medical domain cannot directly create a structured report while scanning the images. In this eyes-busy setting, he can only dictate the finding to a tape-recorder. After the reading process, he can replay the dictation to manually fill out a patient's finding form. Another possibility is to have a clinical assistant complete the form. But since the radiologist has to check the form again, this task delegation does not save much time which is spent on one report. In addition, the form has to be manually transferred into a machine-readable report, which again is very time consuming and prone to errors.

It is therefore an object of the present invention to provide a method and system for annotating image regions that is more efficient and user-friendly.

### SUMMARY OF THE INVENTION

This object is achieved by a method and a system according to the independent claims. Advantageous embodiments of the invention are defined in the dependent claims.

In order to support the knowledge acquisition process of annotating the image regions, the invention proposes a combined user interaction while using touch and speech. The annotations may be based on specific language-independent concepts, i.e. standardized terms or descriptions with unique identifiers. Images with descriptive annotations on specific image regions facilitate a user's access to the images because search engines can use the annotations to search for similar images according to similar annotations on the images.

According to one aspect of the invention, the region identification step may be combined with a speech interaction step to annotate the regions as part of a knowledge acquisition step.

The results of the application of the invention are annotated images with concepts on specific regions. The image annotations can, for example, be used to identify a multidimensional image of a plurality of images. Thus, in an aspect, the invention provides a system for the annotation of multidimensional images based on gestures and natural speech user interaction, the system comprising:
an identification unit for identifying a region of interest on the multidimensional image based on a user input indicating a region on the multidimensional image, and further based on a model for interpreting the user gesture as an identification of a specific region.
an automatic speech recognition unit (ASR) which provides a textual transcription of the spoken user input in a specific natural language in the form of multiple hypotheses. The language grammar of the ASR unit must be adapted to cover all intended user utterances of the intended annotation dialogue.
a natural language understanding unit (NLU) which interprets the ASR output in the form of multiple hypothesis in the context of a specific application domain by using a natural language parser. The outputs of the NLU unit are the ontological concepts used for the annotations in a language-independent form. The natural language parser is language-dependent.
a fusion unit fuses the outputs of the identification and natural language understanding units. The system also comprises
an annotation unit which annotates the result of fusion unit on the image regions and also provides user feedback about the annotation process. The user is also able to refine existing annotations or misinterpreted user input by using speech.

Thus, the system advantageously facilitates the annotation of multidimensional images, based on the fusion of the region identification and the ASR output. The activation of the ASR unit may be triggered by the identification unit. In this way, the ASR activation and the region identification can be performed in one step instead of two subsequent steps.

When the region is identified by holding down a finger on the image region, the activation may be upheld as long as the finger rests on the region. The ASR may be deactivated automatically when the finger no longer rests on the region, comparable to a walkie-talkie activation. Alternatively, the triggered activation may be upheld after the identification step, independent of a finger's resting position and the ASR unit can automatically stop the recording so that the user only needs to identify the region and to utter the desired annotation in complete or elliptic sentences.

In the four embodiments of the system according to the invention described below, the annotation of image regions of multidimensional images is made more interactive through user gestures and natural speech dialogue, thereby offering the user an intuitive way of annotating the image regions which is both user-friendly and efficient.

The invention is particularly useful for the annotation and the subsequent retrieval of medical images. A semantic search in medical databases can be conducted by taking the contents of the image regions into account. Therefore, the annotation of the medical images is essential. But conventional annotation methods for medical images are time-consuming and error-prone.

In an embodiment of the identification unit of the system, identifying the region of interest represented in the multidimensional images comprises:
displaying the multidimensional image on the computer screen of a user terminal or mobile interaction device such as a smartphone.
   obtaining a user gesture input for identifying a region of interest. A region of interest may be identified by a simple click on the image region or by drawing the contour of a region with a bigger 2D surface, for example. Thus, the system helps coping with the situation where the region of interest can be identified by a simple click gesture or a contour drawing with a computer mouse input or a touchscreen input.

Multiple regions on a multidimensional image can be identified on the basis of the user input. A person skilled in the art will appreciate that the multidimensional image in the claimed invention may be 2-dimensional (2-D), 3-dimensional (3-D), or 4-dimensional (4-D) image data.

In at least one embodiment of the system, the multi-dimensional images stem from medical acquisition systems such as X-ray imaging, computer tomography (CT), magnetic resonance imaging (MRI), Ultrasound (US), single photon emission computed tomography (SPECT), and positron emission tomography (PET).

In an embodiment of the system, the ontological concept of a specific region of the multidimensional image may be a simple multidimensional spatial dimension, for example a (x,y) 2-dimensional coordinate based on the identification step. The region may also be a 2-dimensional area or a 3-dimensional volume in the multidimensional image.

In an embodiment of the system, the speech input may be recorded by a microphone of an interaction device such as a smartphone, and the identification unit uses the touch screen of the same interaction device for the identification of the region.

In a further aspect, the knowledge acquisition system according to the invention may be comprised in a database system.

In a further aspect, the knowledge acquisition system according to the invention may be comprised in an image acquisition apparatus.

In a further aspect, the knowledge acquisition system according to the invention may be comprised in a workstation.

In a further aspect, the invention provides a method of annotating multiple images and identifying an image of a plurality of images based on the region annotations.

### BRIEF DESCRIPTION OF THE DRAWINGS

FIG. 1 shows a block diagram of an exemplary embodiment of the system (10);

FIG. 2 shows two exemplary graphical user interfaces (GUIs) of the system according to an exemplary embodiment in the medical imaging domain and an embodiment as an annotation game for children, respectively.

FIG. 3 shows an exemplary embodiment of the imaging acquisition apparatus.

FIG. 4 schematically shows an exemplary embodiment of the workstation.

Identical reference numbers are used to denote the individual units throughout the figures.

### DETAILED DESCRIPTION OF THE EMBODIMENTS

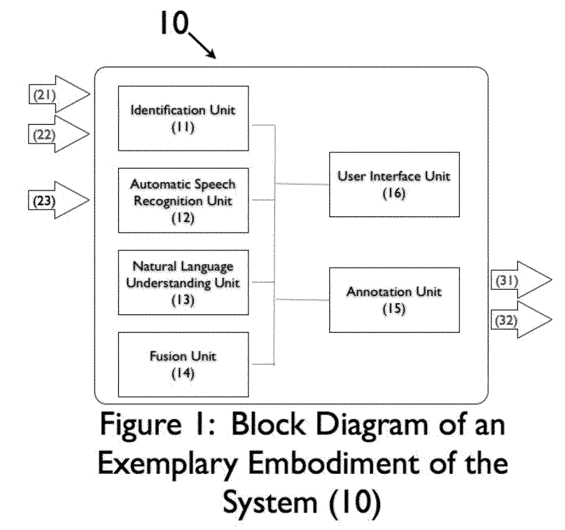

FIG. 1 shows a block diagram of an exemplary embodiment of the system 10 for annotating multidimensional image regions by using gestures and natural speech interaction, based on a multidimensional image.

The system 10 comprises an identification unit 11 for identifying a region of interest on the multidimensional image based on a gesture input by a user indicating a region on the multidimensional image, and further based on a model for interpreting the user gesture as an identification of a specific region. An automatic speech recognition unit (ASR) 12 provides a textual transcription of the spoken user input in a specific natural language in the form of multiple hypotheses. The language grammar of the ASR unit must be adapted to cover all intended user utterances of the intended annotation dialogue. A natural language understanding unit (NLU) 13 interprets the ASR output in the form of multiple hypotheses in the context of a specific application domain by using a natural language parser. The outputs of the NLU unit are the ontological concepts used for the annotations in a language-independent form. The natural language parser is language-dependent. A fusion unit 14 fuses the outputs of the identification and natural language understanding units. An annotation unit 15 annotates the result of fusion unit on the image regions and also provides user feedback about the annotation process. The user is also able to refine existing annotations or misinterpreted user input by using speech.

In an embodiment of the system, there are three input connectors 21, 22, and 23 for the data input. The input connector 21 which is connected to the identification unit 11 is arranged to receive data coming from a data base storage facility such as, but not limited to, a hard disk, a flash memory, or an optical disk. The input connector 22, which is also connected to the identification unit 11, receives data from a gesture-based user input device, such as, but not limited to, a mouse a keyboard, or a touch screen device. The input connector 23, which is connected to the automatic speech recognition unit 12, is arranged to receive audio data from a microphone in preprocessed digital audio packages.

In an embodiment of the system, there are two output connectors 31 and 32 for the output data. The output connector 31 is arranged to output the image region annotations to a data base storage facility such as, but not limited to, a hard disk, a flash memory, or an optical storage. The output connector 32 is arranged to output the annotation feedback to a display device and/or a natural language generation module. The output connectors 31 and 32 receive the output from the annotation unit 15.

The input and output connectors may be implemented by a wired or a wireless connection such as, but not limited to, a local area network (LAN) or a wireless LAN, the Internet, or a digital telephone network.

In a further embodiment of the system, the annotation unit 15 also contains a natural language generation (NLG) unit and a synthesis unit. The NLG unit takes the ontology-based region annotations and provides an annotation feedback in the form of a generated utterance in a natural language. With the help of the NLG unit, a speech-based user-system dialogue in a natural language such as German or English becomes possible. The synthesis unit synthesizes the generated utterance on an audio speaker. Alternatively, the natural language generation and synthesis steps may be implemented in another unit of the system 10.

In an embodiment of the system 10, the system 10 comprises a user interface unit 16. A user interface may be arranged to receive a user input for identifying a region in the multidimensional image and/or to provide annotation feedback or other useful information to the user. A user may indicate a region in the image, using an input device such as his finger or a mouse and drawing a rectangular contour of the region of interest.

The activation of the ASR unit may be triggered by the identification unit. In this way, the ASR activation and the region identification can be performed in one step instead of two subsequent steps.

When the region is identified by holding down a finger on the image region, the activation may be upheld as long as the finger rests on the region. The ASR may be deactivated automatically when the finger no longer rests on the region, comparable to a walkie-talkie activation. Alternatively, the triggered activation may be upheld after the identification step, independent of a finger's resting position and the ASR unit can automatically stop the recording so that the user only needs to identify the region and to utter the desired annotation in complete or elliptic sentences.

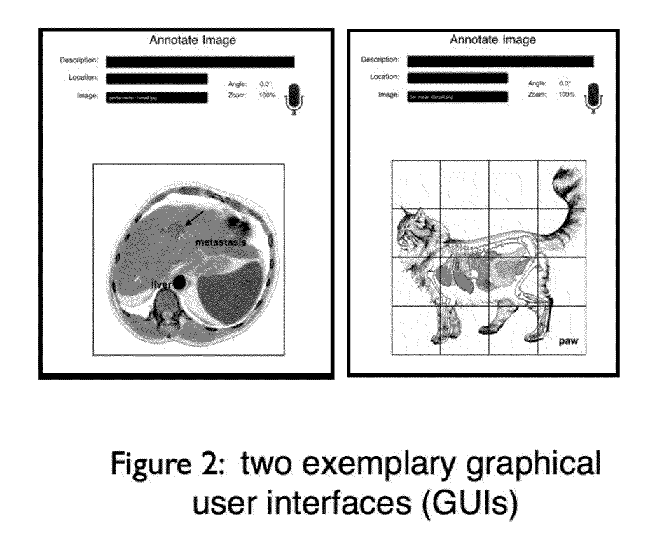

FIG. 2 shows two exemplary graphical user interfaces of the system according to an exemplary embodiment in the medical domain.

If, for example, a radiologist detects a stenosis in a coronary artery, the method and system according to the invention allow him to simply point to the stenosis, dictate “Here's a moderate stenosis, . . . ” which is then be acknowledged by the dialogue system as “Annotated moderate stenosis in proximal segment of the right coronary artery.” In one embodiment of the system, this could also be combined with automatic analysis and detection capabilities of anatomical objects in the multidimensional image.

In FIG. 2 (left), the user, a clinician, is provided with a CT image of the abdomen. He has indicated a region of interest by a click on the screen of a mobile touchscreen device such as a tablet PC. A person skilled in the art will understand that the pixels the user clicks on, may be classified based on another object model, e.g., a deformable 3-D model, and will know suitable image segmentation methods in order to avoid the manual drawing of a complete contour. An exemplary 3-D model comprises a mesh surface. Pixels or contours inside a mesh surface are classified as pixels belonging to a pre-segmented object which indicates the region of interest, thereby identifying the object. In FIG. 2 (left), the user annotated the medical Radlex ontology term ‘liver’ on a specific image position. In addition, the user annotated the medical Radlex ontology term ‘metastasis’ onto a pre-indicated contour according to an object model. The microphone indicates the status of the speech recognition engine. For example, the user-system natural speech dialogue may look like this:

User: “Annotate (+click on region), here, the Radlex term ‘liver’, . . . and this contour (+click on pre-indicated contour) the term ‘metastasis’.”

System: “I annotated ‘liver’ and ‘metastasis’ on two independent regions”+shows a user feedback as a textual annotation on the screen.

User: “Add ‘hodgkin lymphoma’ to the metastasis annotation.”

System: “I added ‘hodgkin lymphoma’ at the respective position.”

In the right frame of FIG. 2, a simple automatic image segmentation method is shown as part of an annotation game for children. The users can indicate a specific rectangular region just by clicking in one of the tiles. The user-system dialogue is similar to the first example: the user clicks on a tile and can indicate a semantic annotation, here “paw”, by using natural speech. The result of the annotation is shown on the tile as the annotation feedback. In all multimodal user situations where the user uses both gestures and speech, activating the ASR is done by the gestural user input. In this way, one may solve the technical problem of activating the ASR in this interaction setting.

In a possible embodiment of the system (10), the annotated concepts may stem from one or more medical ontologies such as FMA, ICD-10, or Radlex or any combination thereof. Such ontologies include concepts and relations among the concepts, for example an is a hierarchical relation or a part-of relation. With the help of this additional structural or topographical information, the speech-based annotation process can be extended. For example, an is a relation allows a user to use a subconcept in an utterance like “annotate with Hodgkin-Lymphoma” and refer to the disease later by a superconcept, e.g., “Add shrunken to the lymphoma case”. The result in this example is an annotation with the ontology concepts:

Hodgkin-Lymphoma+shrunken.

If a medical ontology is employed with a part-of relation, in particular anatomical annotations can be extended automatically. For example, if the user says “Annotate here (+click on a specific image region) with heart chamber”, the identified region of the multimodal image can automatically be annotated with the ontology concept “heart” because the heart chamber is a part of the heart. With these and similar ontology relations, the annotation dialogues can be made much more efficient and user friendly.

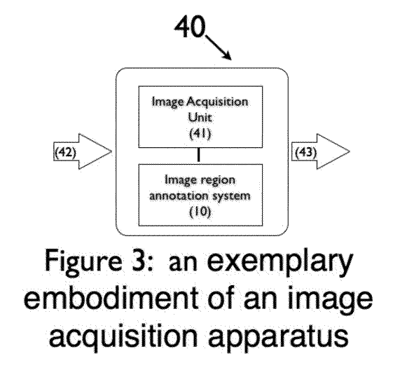

FIG. 3 shows an exemplary embodiment of an image acquisition apparatus 40 employing the system 10 of the invention, said image acquisition apparatus 40 comprising an ontology-based image acquisition unit 41 via an internal connection with the system 10. This arrangement advantageously increases the efficiency and reduces annotation errors of the image acquisition apparatus, providing said apparatus with the gesture and speech based annotation capabilities of the system 10. Thereby, the image acquisition apparatus comprising the system 10 employs the original external input connector 42 and output connector 43.

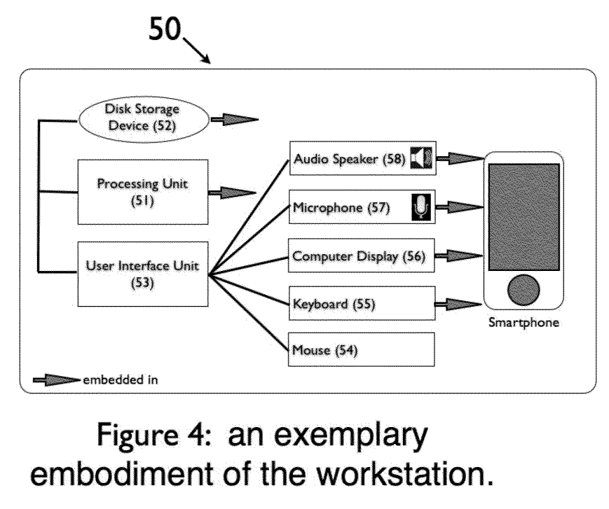

FIG. 4 shows an exemplary embodiment of a workstation 50. The workstation comprises a processing unit 51. A disk storage device 52 is operatively connected to processing unit. A user interface 53 unit is operatively connected to the processing unit 51. A mouse 54, a keyboard 55, a computer display 56, a microphone 57, and an audio speaker 58 are operatively coupled to the user interface 53. The method for annotating image regions according to the invention is implemented as a computer program, is stored in the disk storage device 52. In a further embodiment, the keyboard 55, the computer display 56, the microphone 57, and the audio speaker 58 are embedded into a tablet pc or smartphone. In this case, the mouse 54 can be replaced by the touchscreen of the tablet pc or smartphone. In a further embodiment, the processing unit 51 and the disk storage device 52 are also embedded into the tablet pc or smartphone.

1. System (10) for annotating image regions through gestures and natural speech interaction, based on a multidimensional image, the system (10) comprising:
an identification unit (11) for the identification of a region of interest on the multidimensional image;
an automatic speech recognition unit (12) for recognizing speech input in a natural language;
a natural language understanding unit (13) which interprets the speech input in the context of a specific application domain;
a fusion unit (14) which combines the multimodal user input from the identification unit (11) and the natural language understanding unit (13); and
an annotation unit (15) which annotates the result of the natural language understanding unit (13) on the image regions and optionally provides user feedback about the annotation process.

2. The system (10) of claim 1, wherein identifying a region of interest represented in the multidimensional image comprises:
obtaining a gestural user input for selecting a region of interest, whereby the region is either directly indicated by the user gesture, or determined by automatic segmentation of the indicated region of the multidimensional image.

3. The system (10) of claim 2, wherein recognizing the speech input for generating multiple speech input hypotheses comprises:
activating the ASR by the gestural user input.

4. The system (10) of claim 3, wherein interpreting the ASR output comprises parsing the textual hypothesis and generating one or more semantic interpretations according to the application domain, whereby the semantic interpretations identify concepts to be annotated in the multidimensional image.

5. The system (10) of claim 4, wherein fusing the multimodal user input from the identification unit and the natural language understanding unit identifies concepts to be annotated at a certain image region or position on the multidimensional image.

6. The system (10) of claim 5, wherein annotating a region in the multidimensional image comprises:
annotating the image region with the identified concepts; and
displaying the annotated concepts next to the annotated region.

7. The system (10) of claim 5, wherein confirming the correct annotation step comprises obtaining a user input.

8. The system (10) of claim 1, further comprising a natural language generation unit to generate a textual feedback in complete sentences in a natural language.

9. The system (10) of claim 8, further comprising a synthesis engine unit to synthesize the natural language generation output to be played on a speaker as an auditory user feedback.

10. Database system comprising a system (10) according to claim 1.

11. Image acquisition apparatus comprising a system (10) according to claim 1.

12. Workstation comprising a system (10) according to claim 1.

13. Computer-implemented method (M) of annotating image regions through gestures and natural speech interaction, based on a multidimensional image, the method (M) comprising:
an identification step for the identification of a region of interest on the multidimensional image;
an automatic speech recognition step for recognizing speech input in a natural language:
a natural language understanding step which interprets the speech input in the context of a specific application domain;
a fusion step which combines the multimodal user input from the identification unit (11) and the natural language understanding unit (13); and
an annotation step which annotates the result of the natural language understanding unit (13) on the image regions and optionally provides user feedback about the annotation process.

14. Computer program product, comprising instructions that, when executed by a computer, implement a method according to claim 13.
